(19) United States
(12) Patent Application Publication
(10) Pub. No.: US 2003/0144931 A1
(43) Pub. Date: Jul. 31, 2003

(54) Tax calculator

(76) Inventors: Patricia L. Stokes, Brooklyn, NY (US); David E. Prouhet, O'Fallon, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/252,226

(22) Filed: Sep. 23, 2002

Related U.S. Application Data
(60) Provisional application No. 60/349,180, filed on Jan. 16, 2002.

(51) Int. Cl. G06F 17/60

(52) U.S. Cl. 705/31

(57) ABSTRACT

The invention is a system or method (collectively the “system”) for calculating transaction-based taxes, such as use tax and sales tax. Some of the data used to generate a tax calculation relate solely to the particular transaction. Other data can be potentially be used for several different transactions, and need only be collected and stored once. The tax calculator can generate tax calculations using both transaction data and non-transaction data, although such data can originate and be stored through different mechanisms and sources. The system can be configured to implement and enforce in an automated manner, the tax conclusions and selections provided by the merchant.

### RELATED APPLICATIONS

This utility application claims the benefit of the provisional application titled “INTERNET SALES TAX DETERMINATION METHOD” (Serial No. 60/349,180) filed on Jan. 16, 2002.

### BACKGROUND OF INVENTION

The invention relates generally to systems and methods for calculating transaction-based taxes.

The proper calculation of sales taxes, use taxes, and other transaction-based taxes (collectively “transaction taxes” or simply “taxes”) is not a trivial task. A single transaction can be taxed by several different government authorities. For the purposes of transaction taxes, there are currently over 7,600 jurisdictions (“tax authorities”) in the United States. Multiple jurisdictions can simultaneously exert taxing authority on the same transaction. For example, a single transaction in New York City can result in state, county, city, and local (e.g. zone) taxes. However, different jurisdictions classify transactions differently, resulting in a wide variety of different tax exemptions. For example, an orange can be classified as a taxable fruit in one jurisdiction while considered a non-taxable beverage in another jurisdiction. Each jurisdiction can have distinctly different exemption rules, tax rates, and maximum tax rates. The prior art does not provide an effective solution for this problem. Moreover, the prior art does not provide an affirmative suggestion or motivation to this problem.

Remote transactions (transactions where the buyer and seller are not at the same location) can further complicate the accurate calculation of transaction taxes. Common examples of remote transactions can include transactions that occur via telephone, mail order, the Internet, or some other communication mechanism by which the parties involved in the transaction are located in different jurisdictions. If a merchant has a “nexus” in a particular jurisdiction, that merchant is obligated to collect sales tax on any transactions in the jurisdiction. If no such nexus exists, use taxes are typically incurred by the buyer. Use tax obligations are credited by the amount of sales tax that is paid, but given the variety of different tax rates, the collection of sales tax does not preclude a use tax obligation for the same transaction. In summary, the calculation of transaction taxes can be very complex.

With respect to remote transactions, there is no motivation or suggestion to improve the accuracy of tax calculations. Some companies simply identify the highest tax rate out of all the jurisdictions in which they have a nexus, and charge that high rate on all transactions—resulting in an overcharging of taxes. Such companies have no motivation to improve the accuracy of their tax calculations. Existing techniques teach away from an inexpensive and accurate tool for transaction-based tax calculations.

Costs associated with accurately calculating a transaction tax for a particular transaction can easily exceed the financial value of the collected transaction tax. Conducting business over a wide range of overlapping jurisdictions (there are over 7,600 jurisdictions in the United States) requires access to frequently updated databases, which is a very expense proposition. Smaller business entities are particularly unable or unwilling to incur such costs, yet the vast majority of remote transactions involve sellers that are small businesses.

Competitive pressures between online merchants and retailers is consistently increasing. Antitrust laws substantially prevent efforts by such merchants and retailers to pool together their resources and engage in cooperative and collective activities. However, it would be desirable if the costs of maintaining the infrastructure for tax calculation could be spread out among more than one merchant or retailer.

Changes in tax rules are frequent. Political bodies at all levels of government face budgetary issues that are often reflected in tax rate changes. An effective tax calculator would need to incorporate all updates across the more than 7,600 jurisdictions that exist in the United States. Tax rules overlap between jurisdictions, and the ways in which tax rates interrelate are also subject to frequent changes. It would be desirable if a solution for tax calculation could isolate changes to the software in only one location, instead of needing to distribute the solution to all users. There is no motivation or suggestion in the existing art to consolidate all tax rules across all jurisdictions for multiple combinations of merchants, customers, and products.

The data storage and processing power needed to accurately calculate transaction-based taxes can be a significant burden on the computational device(s) used to calculate the transaction-based tax. It would be desirable if persons or entities desiring to calculate taxes did not need to install significant computer code on their machines in order to calculate transaction-based taxes. There is no motivation or suggestion in the art to achieve these goals.

Much of the data necessary for computing transaction-based taxes requires legal assessments of certain facts or contexts. It may be desirable if such legal assessments to be made by human beings, entered into the system, and applied in an automated way across multiple transactions. It may be desirable for an automated system to incorporate tax rules embodying the intelligence of tax laws generally, and embedded intelligence relating to the situation of a particular merchant. It may be desirable for a merchant to have the ability to change their tax criteria and rules, and have those changes permeate throughout the system with respect to that particular merchant. It may be desirable for a tax calculator to be able to respond to requests for tax calculations in a way that is not observable to the potential purchaser initiating the transaction. The prior art does not include any motivation or suggestions at achieving such goals. In fact, existing techniques affirmatively teach away from such objectives.

### SUMMARY OF INVENTION

The invention is a system or method (collectively the “system”) for calculating transaction-based taxes, such as use tax, sales tax, and other transaction-based taxes (collectively “transaction taxes” or simply “taxes”). Some of the data or characteristics used to generate a tax calculation relate solely to the particular transaction (“transaction data” or “transaction characteristic”). Other types of data and characteristics such as merchant data (a “merchant characteristic”) and subscription data (a “subscription characteristic”) can also be utilized by the tax calculator. The tax calculator can generate tax calculations using a wide variety of different combinations of one or more transaction characteristics and one or more non-transaction characteristics.

In some embodiments of the system, a transaction subsystem can be configured to capture a transaction characteristic from an online shopping cart. A subscription subsystem (which can also be referred to as a setup subsystem or a merchant subscription) can be used to capture a nexus characteristic that can applied to multiple different tax calculations performed on behalf of a particular merchant by a tax calculator.

In some embodiments, different interfaces can be configured to receive different types of data. A transaction interface can be configured to receive transaction characteristics and a merchant interface (which can also be referred to as a subscription interface or a setup interface) can be configured to receive non-transaction characteristics which can potentially apply to more than one transaction.

In some embodiments, all legal conclusions and analysis are supplied by the merchant in configuring the system. In other embodiments, the system itself can be used to generate legal conclusions from underlying facts.

In some embodiments of the system, a merchant or other entity enters subscription characteristics during a setup process while transaction characteristics are entered into the tax calculator on a transaction-by-transaction basis.

### BRIEF DESCRIPTION OF THE DRAWINGS

The embodiments of the present invention will be described in detail, with reference to the following figures, wherein:

FIG. 1 is a block diagram illustrating one example of some of the elements of a system or method for tax calculation.

FIG. 2 is a process-flow diagram illustrating one example of how information for a particular tax calculation can originate from various data sources.

FIG. 3 is a block diagram illustrating one example of a subsystem-level view of a system or method for tax calculation.

FIG. 4 is a block diagram illustrating a different example of a subsystem-level view of a system or method for tax calculation.

FIG. 5 is web site diagram illustrating an example of a home page for an Application Service Provider (ASP) embodiment of the system or method for tax calculation.

FIG. 6 is a web site diagram illustrating an example of a merchant page, along with some examples of functionality relating to merchants and flexibility relating to merchant business rules.

FIG. 7 is web site diagram illustrating an example of an administrator page along with some examples of functionality that can be performed by the administrator of the system or method for tax calculation.

FIG. 8 is a flow chart illustrating one example of a process for capturing transaction data from a merchant web site and some subsequent processing that can be performed.

FIG. 9 is flow chart illustrating one example of processing exemptions and finalizing database transactions.

FIG. 10 is a flow chart illustrating a second example of how a system or method for tax calculation can be invoked by a transaction.

FIG. 11 is a flow chart illustrating a third example of how a system or method of tax calculation can be invoked by a transaction.

FIG. 12 is a flow chart illustrating a login and setup process that can include a nexus selection and the finalization of tax rules.

FIG. 13 is a flow chart of the startup process that can include the online acceptance of a license agreement with the ASP.

FIG. 14 is a flow chart illustrating an example of a tax calculation in the context of overlapping jurisdictions.

### DETAILED DESCRIPTION OF THE EMBODIMENTS

### I. Introduction

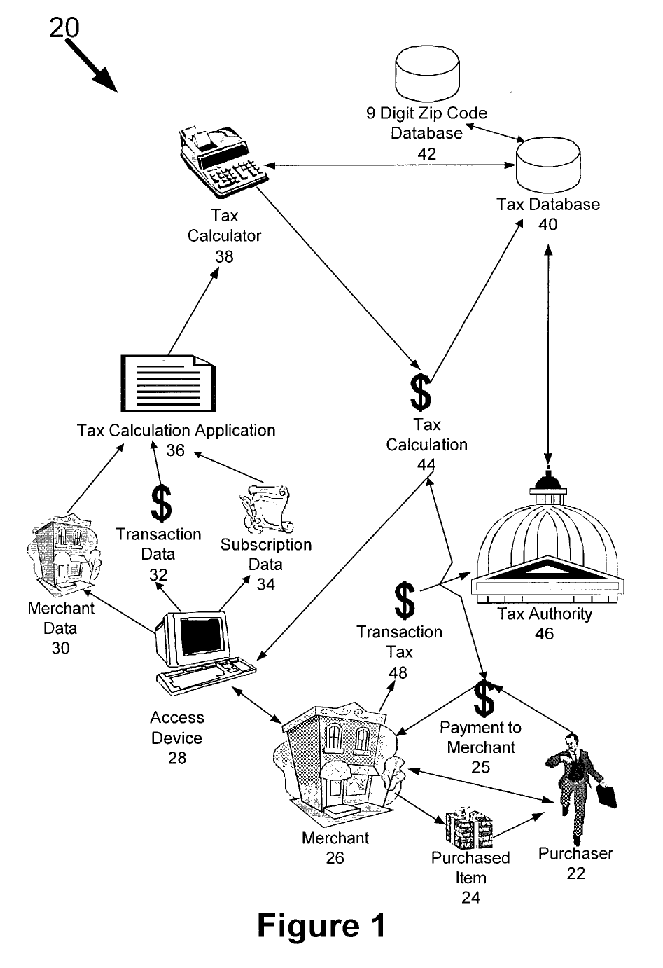

FIG. 1 illustrates an example of a tax calculating method and system (collectively the “system”) 20. The system 20 can be used to calculate sales tax, use tax, or any other transaction-based tax (collectively “transaction tax” or simply “tax”). In a preferred embodiment of the system 20, the legal analysis and judgment (collectively “tax law expertise”) used to generate tax calculations are supplied by the merchant utilizing the system 20. The system 20 can then apply and enforce the tax law expertise in an automated fashion without human intervention. In alternative embodiments, the system 20 can be configured to incorporate expert systems, artificial intelligence and other embedded intelligence technologies (collectively “embedded intelligence”) for the purposes of tax law expertise. In embedded intelligence embodiments, the system 20 itself can apply tax law expertise to the relevant underlying facts in an automated fashion without human intervention.

A. Transactions

Transactions typically consist of purchase transactions between a buyer (purchaser) and a seller (merchant). Transactions can also include rent-to-own transactions, leases, bailment arrangements, consignments, and any other contractual exchange of consideration (collectively a “transaction”) that can potentially result in a transaction tax 48. Transactions include face-to-face transactions as well as remote transactions. Remote transactions can occur via: telephone (both land lines and wireless); mail or a parcel service (“mail order”); video conferencing; computer networks such as intranets, extranets, the Internet, an EDI (electronic data interchange) mechanism or other form of computer network (collectively “network”), or through any other mechanism or process by which transactions can occur without a face to face exchange between the parties.

B. Purchaser

One of the parties to a transaction can be a purchaser 22. The variety of purchasers 22 that can be processed by the system 20 coincides with the variety of transactions that can be processed by the system 20. Thus, the purchaser 22 can be: the buyer in a sale transaction; the buyer in a rent-to-own transaction; a lessee in a lease transaction; a bailee in a bailment arrangement; the possessor in a consignment; or any other person, organization, partnership, corporation, or other entity that receives a good or service in a transaction.

C. Purchased Item

A purchased item 24 is the contractual consideration of the transaction that is received by the purchaser 22. The variety of purchased items 24 that can be processed by the system 20 can vary as widely as the types of transactions. Purchased items 24 can be any good, service, or a combination of goods and services (collectively “purchased items” 24), that can potentially result in a transaction tax 48. In addition to one-time exchanges, purchased items 24 can also be ongoing forms of consideration such as magazine subscriptions or leased equipment,

D. Merchant

A merchant 26 is any person, organization, partnership, corporation, or any other entity (collectively “merchant”), engaged in the transaction with the purchaser 22. The merchant 26 provides consideration in the form of the purchased item 24 to the purchaser 22 in exchange for a payment 25 to the merchant 26 from the purchaser 22. Merchants 26 can be located at a location in the physical world, at a virtual location on a network, or in both physical and virtual locations. Merchants 26 can have one or more locations, in or more jurisdictions. Many merchants 26 function internationally. Just as the system 20 can function with respect to a wide variety of transactions, a wide variety of merchants 26 can also be incorporated into the system 20.

E. Payment

A payment 25 from the purchaser 22 to the merchant 26 for a purchased item 24 can be in the form of cash, credit card, debit card, cyber cash, online payment services (such as ®PAYPAL), check or other negotiable instrument, a loan, or any other payment mechanism. Typically, the payment 25 will include any transaction tax 48 that is due in addition to ancillary charges such as shipping and handling in the case of the shipment of a package. In many embodiments of the system 20, the transaction tax 48 is calculated before the transaction the purchaser 22 and merchant 26 is finalized so that an accurate transaction tax 48 value can be included in the payment 25 required as a result of the transaction. In some embodiments, the payment 25 to the merchant 26 triggers a ping to the tax database 40 that the transaction is good, so that all relevant data can be saved. In an ASP embodiment of the system 20 discussed below, the per transaction charge of the ASP can also be incorporated into the payment 25 by the purchaser 22 to the merchant 26.

F. Access Device

The merchant 26 interacts with the system 20 through an access device 28. In some embodiments of the system 20, the system 20 incorporates a network for facilitating the exchange of information. In a network embodiment of the system 20 that incorporates the Internet, an intranet, an extranet, or some other form of network (collectively “network”), the access device 28 is any device capable of interacting with a network. General purpose computers such as laptops, desktop computers, mainframes, mini-computers, work stations, and other devices can be access devices 28. Programmable logic devices, non-general purpose computers, personal digital assistants (PDAs), cell phones, land-line phones, satellite pages, a wide range of wireless devices, and any other device capable of communicating information can potentially be used as access devices 28 by the system 20.

The system 20 can include many different access devices 28 as alternatives for the merchant 26. In some embodiments, two or more access devices 28 are used in combination with respect to the same data. For example, the system 20 could be configured so that the merchant 28 phones in information via a conventional land line telephone. A computer with voice recognition technology can then convert the information into a form that is more easily processed by the system 20.

In some embodiments, different access devices 28 are used to capture different types of data. For example, in online merchant 26 embodiments, a shopping cart on the web site of the merchant 26 can transparently capture data that is specific to the transaction itself (transaction data). A website for an application service provider (ASP) can be used by the merchant to 26 to provide information relating to the merchant 26 (such as jurisdictions in which the merchant 26 has a nexus) that is not limited to an individual transaction. The ASP website can also be used to set the terms of the subscription service provided to the merchant 26. The ASP can also be referred to as a third party administrator (TPA).

G. Data

There is a potentially wide variety of different data that the merchant 26 can send to a tax calculation application 36 for subsequent processing. Some data relates specifically to the transaction itself, and must be submitted by the access device 28 each time a tax calculation is to be performed. Such data can be referred to as transaction data 32 or transaction characteristics 32. Other types of data (non-transaction data) are utilized in each tax calculation, but only need to be entered once into the system 20. Examples of data that does not necessarily change from transaction to transaction with respect to a particular merchant are merchant data (merchant characteristics) 30 and subscription data (subscription characteristics) 34.

Information relating to the merchant 26 can be referred to as merchant characteristics 30 or merchant data 30. Information relating to the transaction can be referred to as transaction characteristics 32 or transaction data 32. Information relating to subscriptions can be referred to as subscription characteristics 34 or subscription data 34. Other categories of information can be incorporated into the system 20.

1. Merchant Characteristics

A wide range of merchant characteristics 30 can be incorporated into the system 20. Merchant characteristics 30 can include any data that relates to the specific merchant 30 that can be useful in generating tax calculations for the transactions of the specific merchant 30.

One category of merchant data 30 is nexus information. Tax calculations relating to a specific transaction in a particular jurisdiction will differ depending on whether the merchant 26 has a nexus with respect to the particular jurisdiction. In a preferred embodiment, the merchant 26 makes their own legal judgments in determining whether or not a merchant 26 has a nexus in a particular jurisdiction. In such embodiments, the merchant 26 inputs their nexus selection(s) through the access device 28. In alternative embodiments, the system 20 can be configured to automatically determine nexus jurisdictions for a particular merchant 26 based on automated tax intelligence embedded into the system 20. In embodiments where the system 20 makes nexus determinations, all of the data relevant to making those determinations constitute merchant data 30.

Merchant characteristics 30 can include a wide variety of data that is not nexus data. For example, tax exemptions can be based on the identity of the merchant 26. The location of the merchant 26 is another example of a merchant characteristic 30. Merchants 26 can have multiple locations. In some embodiments, locations are in the form of mailing addresses. However, the system 20 can incorporate future developments in positioning technologies, and may incorporate different forms of location information, such as latitude and longitude coordinates, or TCIP address information.

2. Transaction Characteristics

A wide range of transaction data 32 can be incorporated into the system 20. Transaction data 32 can include all data and characteristics that are specific to a particular transaction. Transaction data 32 can include but is not limited to the characteristics of: the particular purchased item(s) 24, the classification of the particular purchased item(s) 24, the identity of the purchaser 22 (such as a purchaser identifier), the jurisdiction in which the transaction occurred, the price of the particular purchased item(s) 24, ancillary costs relating to the purchased item(s) 24 such as shipping costs, and any other information relating to the transaction that is potentially useful in generating a tax calculation 44.

The location of the transaction (which could be the location of the merchant 26, the location purchaser 22, or some other location depending on the applicable tax rule) is another example of a transaction characteristic 32. In some embodiments, locations are in the form of mailing addresses. However, the system 20 can incorporate future developments in positioning technologies, and may incorporate different forms of location information, such as latitude and longitude coordinates, TCP/IP information, or potentially any other means for identifying a location.

3. Subscription Characteristics

Embodiments of the system 20 in which an application service provider (ASP) provides tax calculation services to one or more merchants 26 can include a wide range of subscription data 34. Subscription data 34 can include all data and characteristics that define the subscription relationship between an ASP and the merchant 26. Subscription data 34 can include but is not limited to: a subscription identifier, a subscription contract, a per transaction charge, a flat fee charge, a selection of jurisdiction-specific tax databases, a contract expiration date, and any other information that could potentially be useful for an ASP or a merchant 26 in the providing of tax calculation services.

H. Tax Calculation Application

The system 20 provides information to a tax calculation application 36 through one or more access devices 28 as described above. The information provided to the tax calculation application (the “application”) 36 can include merchant characteristics 30, transaction characteristics 32, subscription characteristics 34, and any other categories of information.

In networked-based embodiments, the application 36 is housed on a server that is potentially accessible from any client device on the network. In Internet embodiments, the application 36 is configured to be accessible from a web browser on any type of computer with Internet access. In a preferred Internet embodiment, the application 36 provides the means by which merchant data 30 and subscription data 34 are inputted into the system 20. In a preferred Internet embodiment, the application 36 provides a means for configuring the capture of transaction data 32 directly from the website of the merchant 26. Thus, a purchaser 22 can provide transaction data 32 to the application 36 without being aware that the merchant 26 is accessing the services of a third party.

I. Tax Calculator

A tax calculator 38 is the engine underlying the application 36 that actually generates a tax calculation 44 utilizing information received from the application 36 and information on one or more tax databases 40. In some embodiments, the tax calculator 38 is fully embedded in the application 36 and thus not distinct from, the application 36. In some embodiments, the tax calculator 38 and tax database 40 are highly integrated, and thus are not distinct from each other.

The tax calculator 38 can be implemented in a wide variety of information technology configurations. In a preferred embodiment, the tax calculator (or simply “calculator”) 38 is written in an object-oriented programming language such as the JAVA® language created by Sun Microsystems. Alternative embodiments may incorporate a wide variety of different programming languages, programming techniques, and information technology components. Any mechanism capable of implementing the process of calculating the transaction tax 44 (described below), is capable of being utilized by the system 20 as a tax calculator 38.

J. Databases

The system 20 can include various mechanisms for the storage of data. In a preferred embodiment, databases such as relational or object oriented databases are used. In alternative embodiments, the storage mechanisms might be flat files, spreadsheets, software objects, various data structures, or any other storage mechanism.

The primary database (or series of databases) used by the system 20 can be referred to as a tax database 40. The tax database can be used for storing both inputs and outputs of the system 20. For example, each tax calculation 44 uses various inputs to generate each tax calculations 44, and those inputs can be stored along with the corresponding tax calculations 44 on the database 40. Data that is reused multiple times, such as merchant characteristics 30 and subscription characteristics 34, can be stored once on the tax database 40 and accessed by the tax calculator 38 as desired. The tax database 40 can also store tax rate information, classification and exemption information relating to categories of purchased items 24, and other information that is not inputted into the system 20 by the merchant 26 or the purchaser 22. In an ASP embodiment of the system 20, the ASP manages and controls the tax database 40. In some embodiments, the tax database 40 can be configured to interface directly with a tax authority 46 from one or more jurisdictions in setting up the various tax rules that apply to a particular jurisdiction. In some embodiments of the system 20 where the ASP is actually responsible for reporting and/or collecting transaction taxes 48 on behalf of the tax authority 46, the tax database can be configured to store additional merchant 30 and purchaser 22 information to assist in such functionality.

In order to facilitate quick and accurate tax calculations, the system 20 can also include a zip code database 42 populated with the information necessary for identifying the nine-digit zip code from the transaction data 32 that includes a transaction location. The nine-digit zip code, in contrast to the shorter five-digit zip code, can be used to precisely identify the relevant jurisdiction(s) of a transaction. The zip code database 42 can be accessed by the tax calculator 38 through a wide variety of different configurations, including through the tax database 40 as illustrated in FIG. 1. The system 20 can incorporate other geography-based databases to identify relevant jurisdictions. The system 20 is sufficiently flexible to incorporate changes in tax laws, and the taxing practices of national, state, county, city, local, and other tax authorities 46.

K. Tax Calculation

A tax calculation 44 can be generated by the tax calculator 38 used by the system 20 before or after a transaction between the purchaser 22 and merchant 26 has been formalized such that it is a legally binding contract. In a preferred embodiment, the tax calculation 44 is generated before the transaction is completed, so that the payment 25 required by the purchaser 22 to complete the transaction can be accurately disclosed to the purchaser 22 before the purchaser 22 is asked to commit to the transaction. The tax calculation 44 can be in a wide variety of different currencies or other financial measurements.

L. Tax Authority

The system 20 can incorporate a wide variety of different tax authorities, including potentially international, national, state, county, city, local (e.g. zone), and other government entities capable of exerting taxes on a transactions. The system 20 is highly flexible, and can be configured to adapt to changes in tax laws and governmental policies relating to transaction taxes 48. In some embodiments of the system 20, tax authorities 46 interact directly with the tax rules stored in the tax database 40. In some embodiments of the system 20, each transaction tax 48 that is incurred is automatically reported to the tax authority 46 without human intervention by the system 20. In some embodiments, the system 20 automatically collects the transaction tax 48 without human intervention on behalf of one or more various tax authorities 46.

M. Transaction Tax

The transaction tax 48 is the amount of tax owed to one or more tax authorities 46 as the result of the transaction. In some embodiments, the amount of the transaction tax 48 is reported to the various tax authorities 46 by the system 20. In some of those embodiments, the system 20 can actually collect the transaction tax 48 in an electronic form (such as using cyber cash, a credit or debit card number, an electronic payment mechanism such as ®PAYPAL, or some other mechanism). The transaction tax 48 is typically a sales or use tax, but the system 20 is sufficiently flexible to include other types of transaction-based taxes. In some ASP embodiments of the system 20, the fee for the ASP is added the payment 25 required by the purchaser 22.

In some embodiments of the system 20, the tax database 40 is pinged after a transaction is finalized, triggering the storage of all relevant data in the database 40.

### II. Data Sources

As discussed above, the system 20 can incorporate information from a wide variety of different information categories. Some information, such as transaction characteristics 32 relate to the specific transaction and do not apply outside the scope of the specific transaction. Other information, such as merchant characteristics 30 and subscription characteristics 34 can potentially be re-used for a voluminous number of different transactions. These distinctions can be reflected in the components and processes used by the system 20.

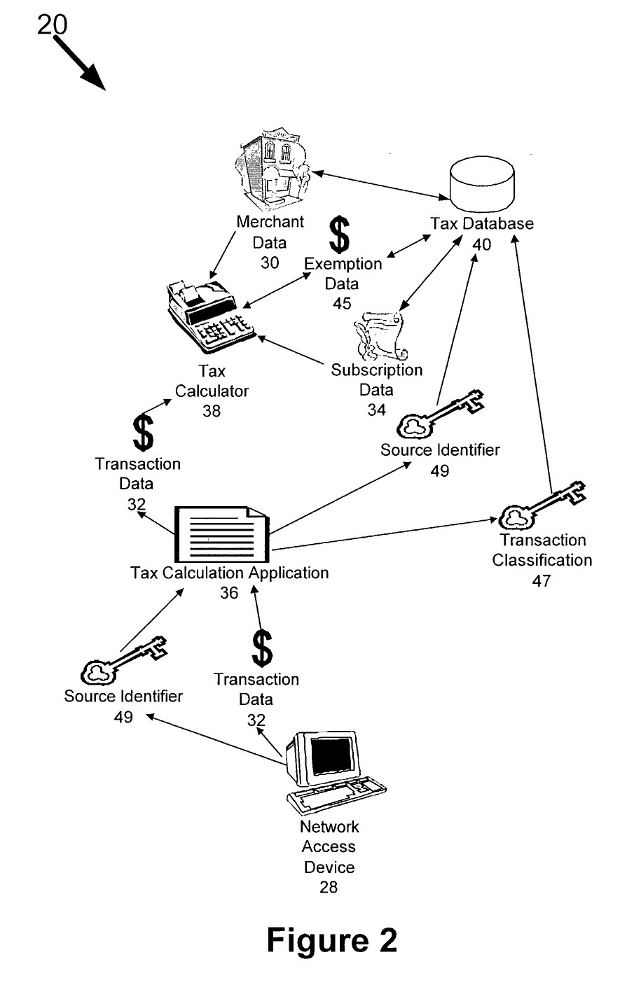

FIG. 2 is a block diagram illustrating one example of ASP embodiment where some of the various information types can be found by the system 20. The access device 28 is the source of the transaction data 32 and a source identifier 49. As discussed above, the access device 28 for transaction data 32 and the source identifier 49 can a shopping cart on the website of the merchant 26. The source identifier 49 can be identifier the merchant 26, or a subgroup of the merchant 26, such as a subsidiary or office location. In some embodiments, the source identifier 49 relates to the subscription. A single merchant 26 can have multiple subscriptions and multiple locations. Similarly, several merchants 26 can potentially share the same subscription and the same location.

As discussed above, the transaction data 32 is received by the application 36, and forwarded on the tax calculator 38. However, transaction taxes 48 can depend on the type or nature of the transaction. Orange juice may be taxed differently from oranges, and foods may be taxed differently than other goods, while services may be taxed differently than goods. Tax authorities 46 typically create complex and often arbitrary distinctions between various types of transactions that should be incorporated into the ways in which the system 20 generates tax calculations 44. The application 36 can identify a transaction classification 47 from the transaction data 34. The transaction classification 47 and the source identifier 49 can be forwarded on to the database 40 so that relevant merchant data 30, exemption data 45, and subscription data 34 can be sent to the tax calculator 38 in addition to the transaction data 32 that was received by the application 36. By storing reusable information on the database 40, the input required from the access device 28 is minimized, and the computational requirements of the access device 28 are also minimized. In an ASP embodiment, the ability to capture, store, and maintain the complexities of tax calculation 44 remotely from the merchant 26 and the access device 28 allows costs to by minimized and distributed across multiple merchants 26 accessing the system 20. The cost of the system 20 per transaction can thus re reduced.

### III. Subsystem View

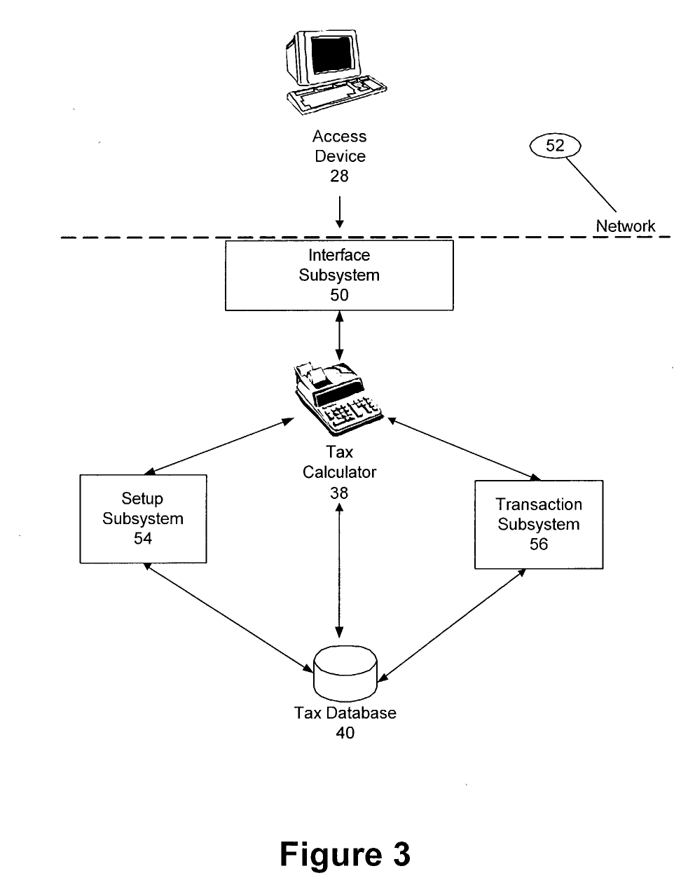

FIG. 3 is a block diagram illustrating one example of a subsystem-view of the system 20. The system 20 disclosed in FIG. 3 includes a network 52. With the exception of an access device 28 residing on the client side of the network 52, all other components are included in the server or ASP side of the network 52.

A. Interface Subsystem

The access device 28 communicates with an interface subsystem 50 on the server side of the network 52. The interface subsystem 50 can be responsible for capturing relevant information from the merchant 26, the purchaser 22, relevant tax authorities 46, and other sources.

The interface subsystem 50 can be divided into a transaction interface for receiving transaction data 32, a subscription interface for receiving subscription data 34, and a merchant interface for receiving merchant data 30. In ASP embodiments, a signup interface (which can also be referred to as a subscription interface) can be used to capture data that is not limited to a particular transaction.

B. Transaction Subsystem

A transaction subsystem 56 can be responsible for processing and accessing transaction characteristics 32 discussed above. The transaction subsystem 56 is responsible for processing information that is limited in scope to the particular transaction between the particular purchaser 22 and the particular merchant 26 for the particular purchased item(s) 24. The only limits to the number of transactions that can be processed by the transaction subsystem 56 are the inherent limits to the infrastructure configuration utilized by the system 20. The transaction subsystem 56 can be configured to receive transaction characteristics 30 from a variety of different sources, including an online shopping cart on a merchant's website. As discussed above, transaction characteristics 32 can include a cost, a location, a classification, a currency, a purchaser, and any other potentially relevant characteristic. Five digit zip codes and nine digit zip codes can be generated by the system 20 from the location characteristic. A wide variety of cost information can be included as transaction characteristics 32, including shipping costs, service charges, and other charges to the purchaser 22. The transaction subsystem 56 can be configured to receive transaction characteristics 32 from an online shopping cart. Certain types of purchased items 24 can be exempt on the basis of a category or classification relating to the purchased item 24. The transaction subsystem 56 can identify potential exemptions relating to a particular transaction in a particular jurisdiction.

C. Setup Subsystem

A setup subsystem 54 can be responsible for processing and accessing information required by the tax calculator 38 that is not limited to the specific transaction. Merchant data 30 and subscription data 34 are examples of data that can be processed, updated, and maintained from the setup system 54. Because merchant characteristics 30 are typically an important aspect of the setup process, the setup subsystem 54 can also be referred to as a merchant subsystem in some embodiments. In ASP embodiments where the system 20 is provided to multiple merchants by an ASP, the setup subsystem 54 can also be referred to as a subscription subsystem or a signup subsystem because the characteristics of the subscribing merchant do not typically change with each transaction.

The setup subsystem 54 can be the mechanism by which subscription contracts are executed between merchants 26 and the ASP. In some embodiments, the contract between the merchant 26 and the ASP is a click-wrap license (e.g. click license) that provides for a per transaction charge. A click license is a contract that is executed online, with the merchant 26 indicating their assent to the terms of the contract by clicking an “I agree” button. In such embodiments, if the merchant 26 does not agree, they can be prohibited from utilizing the services of the ASP. The setup subsystem 54 can define the various fees charged by the ASP, including a per transaction charge, a flat fee charge, and other charges.

Exemptions can relate to particular entities, such as purchasers 22 and merchants 26, and thus the setup subsystem 54 can be used to receive, modify, apply, enforce, and modify exemption information. An exemption module within the setup subsystem 54 can be used to create and enforce a list of exempt customers, as well as a list of classifications relating to exemptions.

The setup subsystem 54 can also provide the means for receiving, storing, updating, selecting, applying, and enforcing the nexus characteristics of the merchant 26. In a preferred embodiment, the merchant 26 uses a nexus module within the setup subsystem 54 to select the jurisdictions in which the merchant 26 has a nexus for tax law purposes. In alternative embodiments, the nexus module itself makes the determination applying the tax rules of the relevant tax authority 46.

The tax database 40 and tax calculator 38 can perform the functions discussed above. In some embodiments, the tax database 40 can be referred to as a data storage subsystem and the tax calculator can be referred to as a calculator subsystem.

In a preferred embodiment, any subsystem in the system 20 can communicate directly with any other subsystem in the system 20. In alternative embodiments, there can be more restrictions on the ability of various subsystems to interact directly with other subsystems.

### IV. Alternative Subsystem View

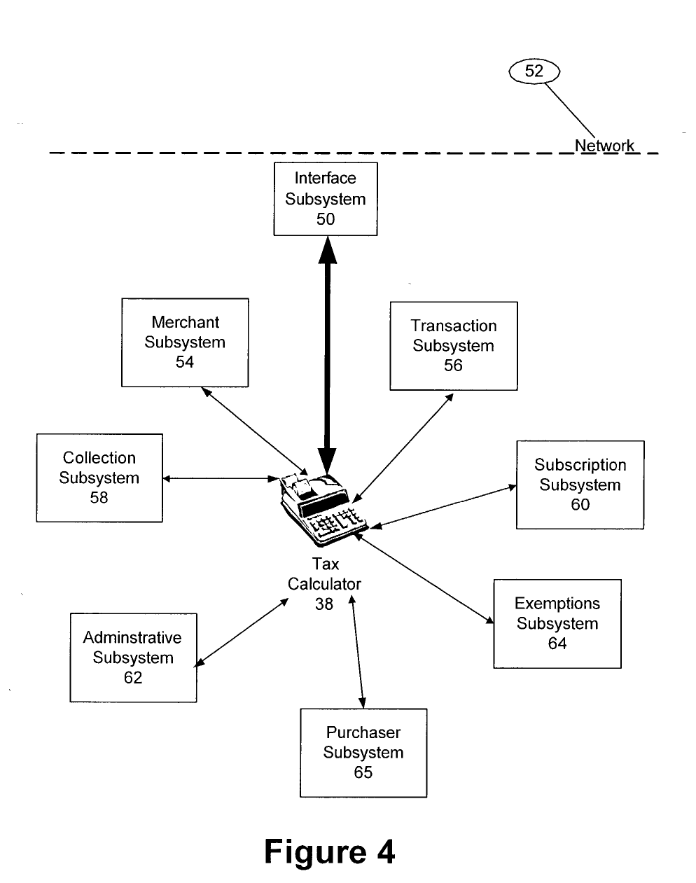

FIG. 4 is a block diagram illustrating another example of a subsystem view of the system 20.

A. Interface Subsystem

The interface subsystem 50 can be responsible for receiving all information relating to merchants 26, subscribers, purchasers 22, purchased items 22, tax rules implemented by tax authorities 46, and any other data, information, or characteristics required by the system 20 to generate a tax calculation 44.

B. Transaction Subsystem

The transaction subsystem 56 can be responsible for all processing relating to transaction data 32. The classification of a purchased item 24 and the price of the purchased item 24 can be important inputs for the tax calculator.

C. Merchant Subsystem

The merchant subsystem 54 can be the means for adding, modifying, applying, deleting, updating, or otherwise accessing merchant characteristics 30.

D. Collection Subsystem

A collection subsystem 58 can be used by the system 20 to automatically collect the transaction 48 tax for a particular transaction without human intervention. The payment of the transaction tax 48 can be received in a wide variety of different forms, including cyber cash, credit card, debit card, wired funds from a bank, or some type of online payment mechanism such as ®PAYPAL.

E. Subscription Subsystem

A subscription subsystem 60 can be used for all processing relating to subscription data 34. The subscription subsystem 60 can be used to configure the way a specific merchant 26 interacts with the system 20.

F. Administrative Subsystem

An administrative subsystem 62 can be used to manage the overall system 20. In an ASP embodiment, the administrative subsystem 62 can be managed by personnel from the ASP. The administrative subsystem 62 can be used to update the licenses subscribers are asked to agree to. The administrative subsystem 62 can also be potentially empowered to modify merchant data 30, subscription data 34, and alter the criteria and tax rules of the system 20.

G. Exemption Subsystem

An exemption subsystem 64 can be used to process exemptions of all types, including exemptions based of product classifications, the identity of the merchant 26, the identity of the purchaser 22, the date in which the transaction takes place, the location of the transaction, or any potential exemption characteristic. In some embodiments, the exemption subsystem 64 can interact directly with taxing authorities 46 to minimize the time between governmental decision making and the implementation of those decisions. The ways in which exemptions can interact with the exemptions of other jurisdictions can also be managed by the exemption subsystem 64.

H. Purchaser Subsystem

A purchaser subsystem 65 can be configured to process, input, update, modify, and delete all information relating to purchasers 22. In some embodiments, some of those functions may be performed by the exemption subsystem 64 or some other subsystem.

### V. Web Site Diagrams

A. Home Page

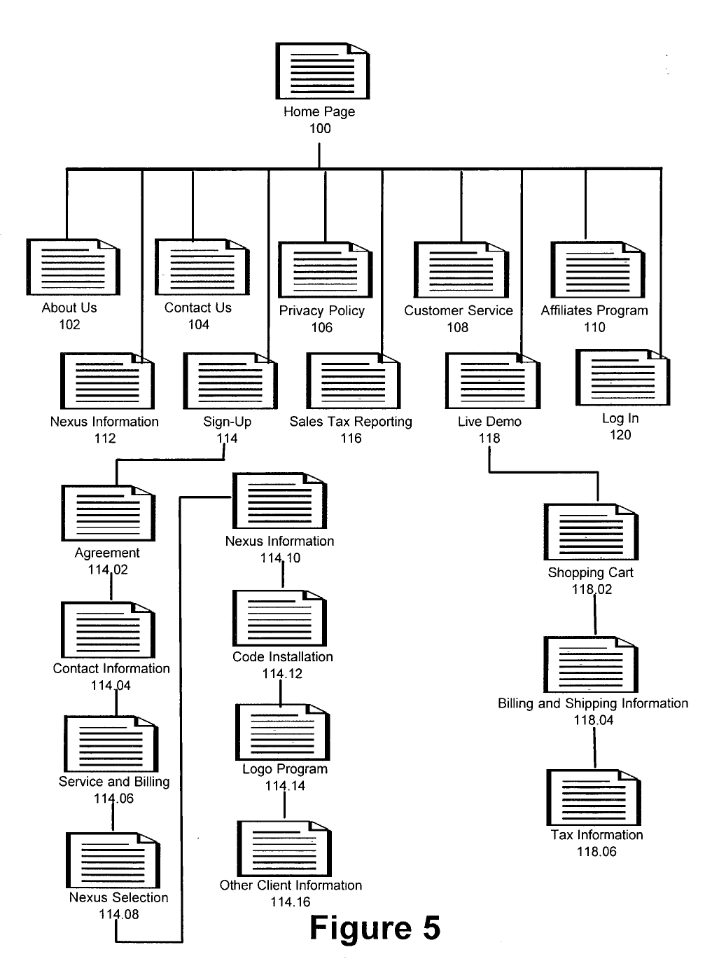

FIG. 5 is a web site diagram illustrating one example of an ASP home page 100. In many embodiments of the system 20, tax calculations 44 are generated at the web site of an ASP after receiving transaction data 32 and a source identifier 49 for obtaining data relating to the merchant 26 or subscriber. In some embodiments, taxing authorities 46 also interact with the system 20. The system 20 can be configured to automatically report all transactions and tax calculations 44 to tax authorities 46 without human intervention. The system 20 can also be configured to automatically collect all transaction taxes 48 and forward those monies to the relevant tax authorities 46.

From the home page 100, customers and potential customers of the ASP (collectively “customers,” “users,” or “subscribers”) accessing the web site can visit the “about us” page 102, where they can learn more about the ASP and the services provided by the ASP. A “contact us” page 104 can be used to initiate subsequent communications between the ASP and its subscribers. A “privacy policy” page 106 provides information to ASP customers and perspective ASP customers of the ASP regarding the privacy policy of the ASP and the web site. The privacy policy can be updated as desired. A “customer service” page 108 can be used by the ASP to describe the customer services provided by the ASP and potentially, various customer service options that can be selected by subscribers. An “affiliates program” page 110 can be used to describe, facilitate, and maintain various business relationships with subscribers. A “nexus information” page 112 can be used to describe current standards for nexus determinations. As tax laws change, the nexus information page 112 can be changed to accurately incorporate those changes. A “sales tax reporting” page 116 can provide information to subscribers regarding reporting requirements from various tax authorities 46. A “log in” page 120 can be used by subscribers and other entities with active accounts with the ASP to actually use the system 20 to generate tax calculations 44.

If an entity is not currently a subscriber and does not have some affiliation with the ASP, subscriber relationships and other relationships, can be created through the use of a “sign up” page 114. An agreement page 114.02 includes a license agreement or contract between the ASP and the user. In some embodiments, the license agreement is a “click-wrap” license (e.g. “click license”) that can be executed by merely clicking on a button signifying acceptance to the terms. Such agreements can include per transaction pricing and/or flat fee pricing. In a click license embodiment, if the user does not agree to the terms, they cannot progress to the “contact information” page 114.04 where the user provides the ASP with contact information for future use.

A “service and billing” page 114.06 can be used by the user to select among service and billing options provided by the ASP. These options can vary dynamically based on the identity of the user, and subscriber characteristics 34 and/or merchant characteristics 30.

A “nexus selection” page 114.08 can be used by merchants 26 to select the jurisdictions in which they have a nexus for tax law purposes. In some embodiments, the system 20 makes the determination(s) itself, based on input provided to the system 20 by the user. A “nexus information” page 114.10 can confirm the selections made by merchants 26 on the prior page. In some embodiments, the system 20 can be configured to automatically perform its own determinations, prompting the merchant 26 to confirm certain nexus determinations.

In some embodiments, some software is loaded on the access device 28 used by the merchant 26. Such software exists on the client side of the ASP network 52, instead of the server side of the network 52. The benefit of such embodiments is the ability to perform tax calculations even if the network 52 is temporarily not functioning or not functioning properly. In some embodiments, the system 20 selectively identifies the types of code and data likely to be required by the particular merchant 26 in order to minimize the amount of code and data stored on the access device 28. The installation of code and data can be performed from a “code installation” page 114.12.

In order to better market the services of the ASP and to provide purchasers 22 with confirmation that their transaction taxes 44 are being calculated in an accurate manner, the ASP can provide a “logo program” page 114.14 to encourage merchants to include the ASP's logo on the merchant's web sites. Additional information can be obtained through an “other client information” page 114.16.

The home page 100 also provides access to a “live demo” page 118. The process of putting items in a shopping cart can be disclosed on a “shopping cart” page 118.02. The process of generating billing and shipping information can be illustrated on a “billing and shipping information” page 118.04. An example of using that information to generate tax information can be provided on a “tax information” page 118.06.

B. Merchant Page

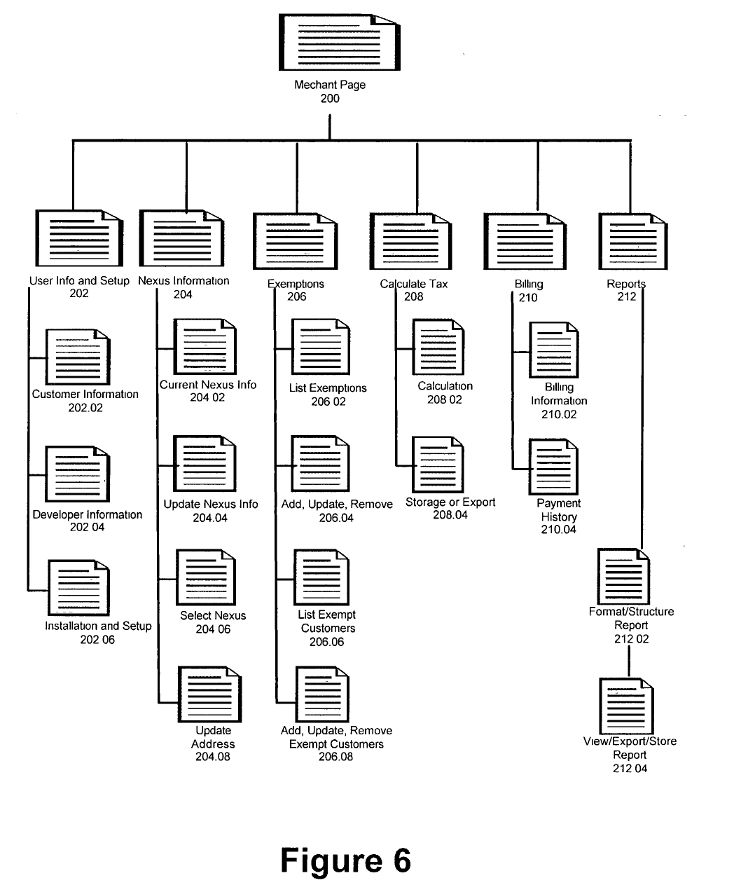

FIG. 6 illustrates an example of web page diagram for a merchant page 200. The merchant page 200 provides merchants 26 and potentially other users and/or subscribers the ability to manage their data on the system 20 that is not limited to a particular transaction. Merchant data 30 and subscriber data 34 can be added, updated, and deleted from the various merchant pages 200.

1. User Information and Setup

A “user information and setup” page 202 includes a series of pages for capturing merchant data 30 and subscriber data 34, while configuring the system 20 for use with respect to the particular merchant 26.

A “customer information” page 202.02 can be used to capture merchant data 30 and subscriber data 34. Profile information, functionality preferences, and other data can be captured.

A “developer information” page 202.04 can be used to facilitate technical integration between the merchant's 26 information technology resources and the ASP. For example, the ability to seamlessly send data from an online shopping cart located on the merchant's website to the system 20, certain customized development and/or programming tasks may need to be performed.

An “installation and setup” page 202.06 can be used to configure the system 20 to the specifications and selections of the merchant 26. In some embodiments, software code and data is actually loaded onto the access device 28 of the merchant 26. In such embodiments, the software and data are loaded from the “installation and setup” page 202.06.

2. Nexus Information

A “nexus information” page 204 can be used to input, modify, delete, and maintain nexus information relating to a subscriber or merchant 26. The “nexus information” page 204 can be described as a nexus module.

Existing nexus information can be viewed from a “current nexus information” page 204.02. Nexus information can be updated from an “update nexus information” page 204.04. In some embodiments, nexus selections are made from a “select nexus” page 204.06 by the merchant 26 actually selecting one or more jurisdictions. In other embodiments, the merchant 26 provides some of the underlying information, and the system 20 makes the nexus determinations itself. Address information can be updated from an “update address” page 204.08.

3. Exemptions

An “exemptions” page 206 can be used by merchants 26 and other users of the system 20 to create, update, delete, and maintain exemption data. The functionality of the “exemptions” page 206 can be referred to as an exemptions module.

Current exemptions based on product classifications that are relevant to the merchant 26 can be viewed on a “list of exemptions” page 206.02. Exemptions can be added, updated, or removed from an “add, update, remove” page 206.04. Exemptions can also relate to the identity of the purchaser 22. A list of existing exempt customers can be viewed from a “list of exempt customers” page 206.06. Customer-based exemptions can be added, updated, or removed from an “add, update, remove exempt customers” page 206.08.

4. Calculate Tax

A “calculate tax” page 208 can be used to configure the tax rules for a particular merchant 26 or subscriber. A “calculation page” 208.02 can be used to perform calculations 44 for a particular transaction in a manual or automated manner. A “storage or export” page 208.04 can be used to configure the way in which tax calculations 44 are stored or exported for a particular merchant 26 or subscriber.

5. Billing

A “billing” page 210 provides the subscriber or merchant 26 with financial data relating to the relationship of the subscriber or merchant 26 with the ASP. Currently billing information can be provided through a “billing information” page 210.02. Past payment history can be viewed through a “payment history” page 210.04. Information relating to per-transaction charges and flat-fee subscription charges can be viewed from the various “billing” pages 210.

6. Reports

A “reports” page 212 can be used to invoke template report formats, create new report templates, and create ad hoc reports. A “format/structure report” page 212.02 can be used to format ad hoc and reusable template reports. A “view/export/store report” page 212.04 can be used to generate reports with configure the ways in which data is stored and/or exported.

C. Administrator Page

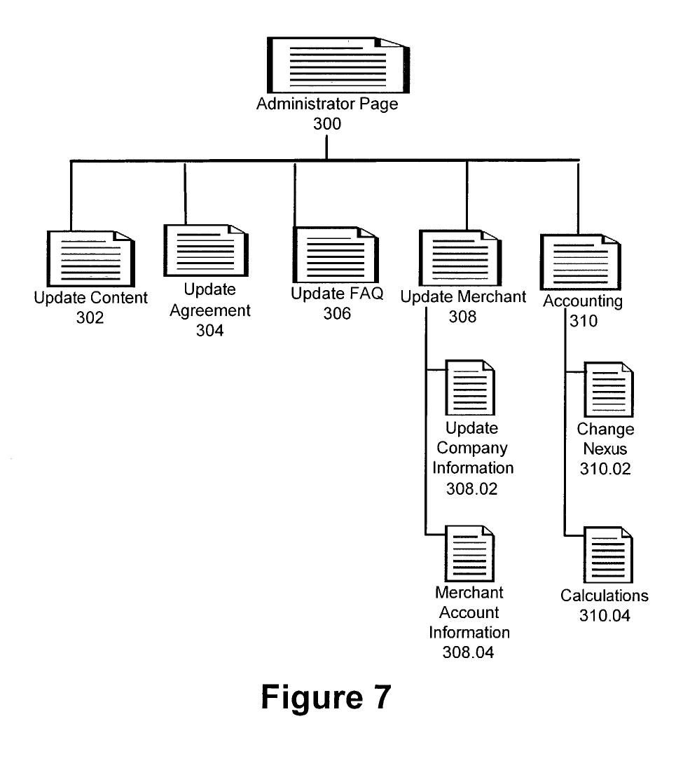

FIG. 7 is a web page diagram illustrating an example of an administrator page 300. The administrator page 300 can be used personnel from the ASP, and in some embodiments, the merchant 26, to add, modify, and delete functionality from the system 20.

An “update content” page 302 can be used to add, update, or remove content from the website. An “update agreement” page 304 can be used to make changes to the click license described above. An “update FAQ” page 306 can be used to add, update, and delete text from a frequently asked questions page.

An “update merchant” page 308 can be used by a third party such as an ASP to update merchant data 30. Company information can be updated on an “update company information” page 308.02. Information relating to the merchant's 26 account with the ASP (e.g. subscription data 34), can be accessed from a “merchant account information” page 308.04.

An “accounting” page 310 can be used to access a “change nexus” page 310.02 and a “calculations” page 310.04. The pages can be used to manage the accounting and tax rules applied by the system 20. The system 20 is highly adaptable, and can be configured to implement merchant-based customizations.

### VI. Process-Flow Views

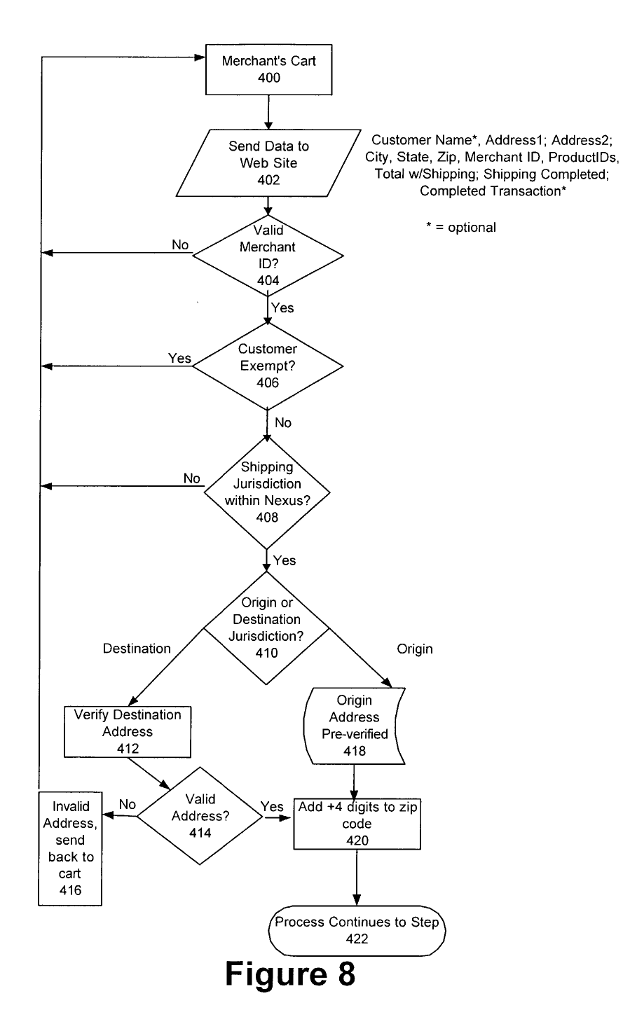

FIG. 8 is a flow chart diagram illustrating an example of a process flow beginning with the sending of data from a merchant's cart at 400 and ending with the transformation of a 5 digit zip code to a 9 digit zip code at 420.

A merchant's cart at 400 is located on the web site of the merchant 26. The cart can capture a wide variety of different information. At 402, certain data is sent to the ASP web site. In many embodiments, the data sent will include a: customer name, address information, merchant ID, product ID(s) relating to the particular transaction, total cost, shipping cost, and a transaction completed flag. Other embodiments will include a different variety of data and characteristics.

At 404, it is determined whether or not the merchant 26 providing the information is a subscriber or is otherwise listed on the system 20. If the sender is not identifiable by the system 20 given the data sent at 402, the process returns to the shopping cart at 400. If the sender is listed at 404, the process continues to 406 to determine whether or not the customer is exempt. If the customer is exempt 406, no taxes are due, and the process returns to the cart at 400 with a determination that no taxes are due. If the customer at 406 is not exempt, the process continues to a shipping/nexus comparison at 408.

At 408, if the shipping jurisdiction is not a nexus jurisdiction, then no sales tax are due, and the process returns to the shopping cart at 400 with no sales tax due. In some embodiments, the process continues because use taxes may be due.

At 410, a determination is made by the system 20 whether or not the shipping jurisdiction is a destination jurisdiction or an origin jurisdiction. If the jurisdiction at 410 is a destination jurisdiction, the destination address is verified at 412. If the address at 414 is invalid, the address is identified as invalid, and the process returns to the merchant's cart at 400. If the address is valid at 414, the system 20 references a nine-digit zip code database 42 to generate a nine-digit zip code for the shipping destination at 420.

If the system 20 at 410 determines that the jurisdiction is an origin jurisdiction, the origin address is pre-verified at 418. In other embodiments, origin address (the merchant's address) can be verified at 418 in the same way that destination addresses are verified at 412. At 420, a nine-digit zip code can be generated from the origin address.

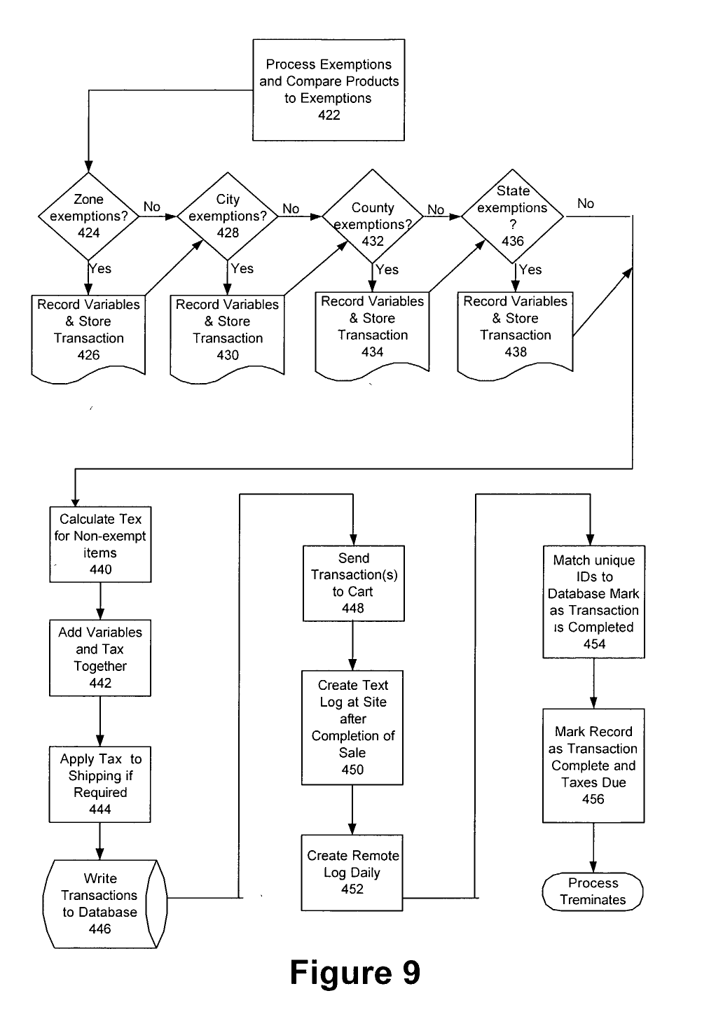

Regardless of whether the jurisdiction is an destination or origin jurisdiction, valid addresses can be used to generate nine-digit zip codes for subsequent processing at 420. The process at 422 continues on FIG. 9.

FIG. 9 discloses an example of a flow chart that continues where FIG. 8 ended. FIG. 9 illustrates an example of system 20 processing from jurisdiction-based exemption processing at 424 through the recording of a transaction at 456.

At 422, product classifications in the purchased items 24 are compared to product-based exemptions at the various jurisdictions which may relate to the transaction. Zones are subsets of cities. A single city can have many different zones or “localities.” If zone exemptions exist at 424, relevant data is stored at 426. If city exemptions exist at 428, relevant variables are stored at 430. If county exemptions exist at 432, relevant variables are stored at 434. If state exemptions exist at 436, relevant variables are stored at 438.

At 440, transaction taxes are calculated for non-exempt items. At 442, all variables and taxes are added together. At 444, taxes are applied to shipping charges, as required by the various jurisdictions. At 446, transactions are written to the tax database 40. At 448, the transaction information can then be sent back to the shopping cart on the merchant's 26 web site. At 450, a text log can be created at the web site after completion of the sale. At 452, a remote daily log can be created at the merchant's site for the convenience of the merchant 26. Logs can also be created for purchasers 22 and tax authorities 46.

At 454, unique Ids are matched to the database as a transaction is executed by the purchaser 22 and merchant 26. All relevant records at 456 are marked as completed, with tax being due. In some embodiments, a report is sent at 456 to the various tax authorities. In some embodiments, the system 20 itself collects the transaction tax 44 and forwards that payment to the tax authority 46.

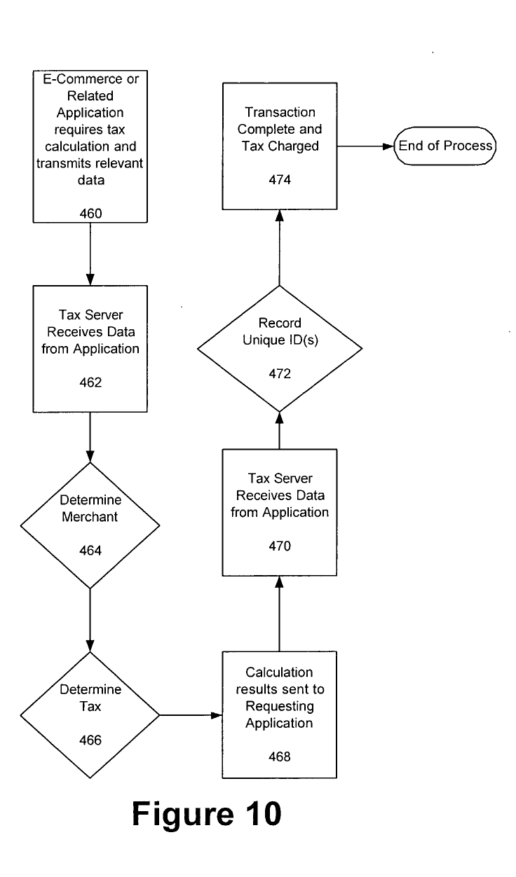

FIG. 10 is an example of a flow chart describing a process from an e-commerce transaction at 460 through the completion of a transaction with tax charges at 474.

At 460, an e-commerce or related application that requires a potential tax calculation 44 requests a tax calculation 44 from the system 20. At 462, the network server of the ASP receives relevant transaction data 32 and at least one source identifier 49. At 464, the system 20 determines the identity of the merchant 26 and relevant merchant characteristics 30 from the source identifier 49.

At 466, the system 20 generates a tax calculation 44 using the tax calculator 38. At 468, the tax calculation 44 is sent to the requesting merchant 26 web site or application. At 470, the network server for the ASP receives data from the merchant's 26 web site or application, confirming the execution of the transaction. At 472, all unique IDs such as merchant ID, subscription ID, product ID, and other identifiers are captured by the system 20 and recorded in the tax database 40. At 474, the transaction is completed with transaction charges being identified as due.

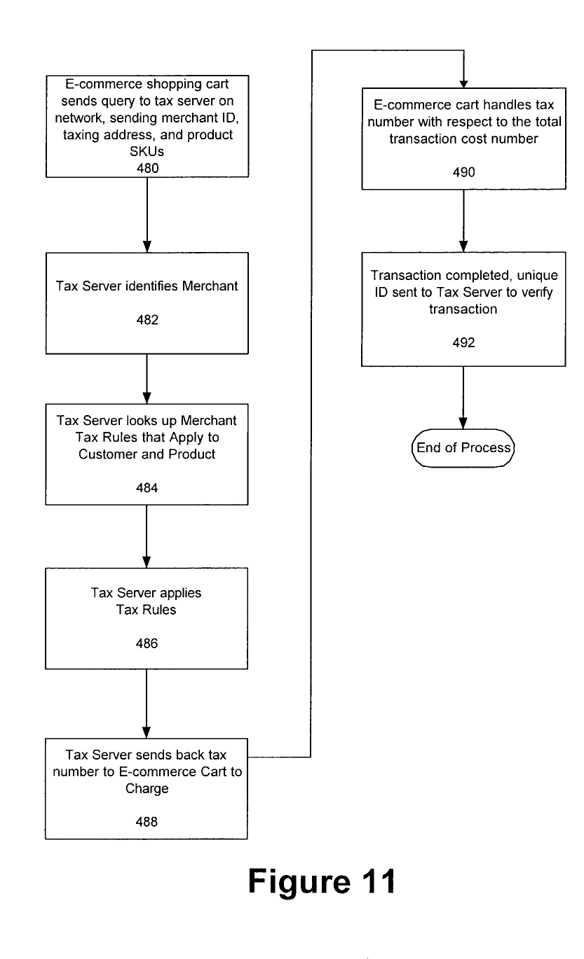

FIG. 11 is a flow chart illustrating a second example of a process flow beginning with the tax calculation 44 request at 480 of an e-commerce shopping cart from a merchant 26 web site to the finalizing of a transaction at 492.

At 480, an e-commerce shopping cart can send transaction data 32 including product classifications relating to purchased items 24 and potential product exemptions, to the system 20. One or more source identifiers 49 can also be sent.

At 482, the system can identify the merchant 26 through the use of the source identifier 49.

At 484, the system 20 can look up the tax rules for the particular merchant 26, as entered through the “merchant” page 200.

At 486, the system 20 can apply the tax rules configured for the particular merchant 26, to the transaction involving the particular merchant 26.

At 488, the system 20 can send back the tax calculation 44 to the e-commerce cart so that the transaction tax 48 can be included in the requirement payment 25 to the merchant.

At 490, the e-commerce cart can list the total payment 25 required for completion of the transaction.

At 492 the transaction is completed, with all relevant unique IDs and other data being stored on the tax database 40.

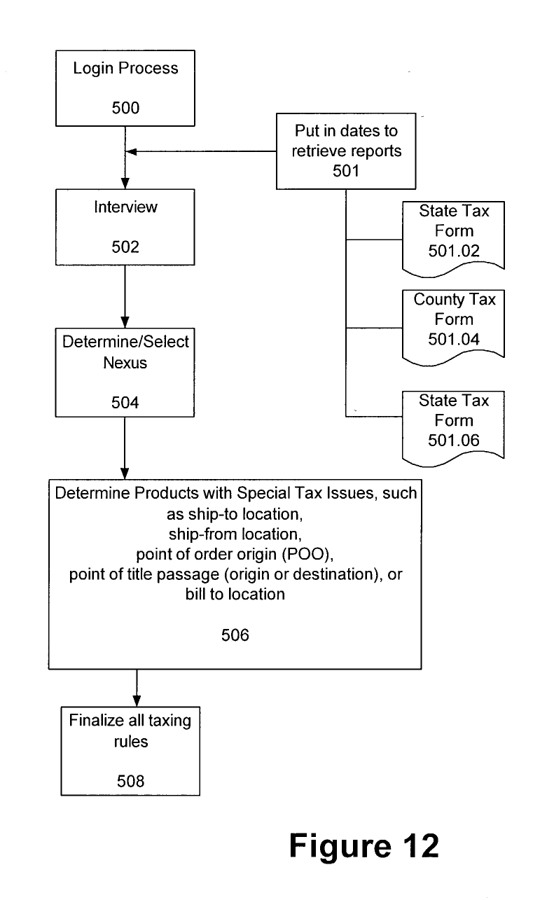

FIG. 12 is a flow chart illustrating one example of a setup process for a merchant 26 or other forms of subscribers. A login process is performed at 500. At 501, dates are inserted into predetermined tax forms such as a state tax form at 501.02, a county tax form at 501.04, a state tax form at 501.06, and any other tax forms for relevant tax authorities 46.

An interview is conducted at 502. In many embodiments, this is an automated exchange between the merchant 26 and predetermined business rules in the system 20. In other embodiments, a human being acts on behalf of the ASP.

Nexus jurisdictions are determined at 504. In many embodiments, the merchant 26 makes nexus selections. In other embodiments, the system 20 applies legal judgments to facts supplied by the merchant 26.

At 506, the system 20 can identify purchased items 24 with special tax issues such as a ship-to location, a ship-from location, a point or order origin (POO), a point of title passage (origin or destination), or a bill to bill location. All taxing rules can be finalized at 508.

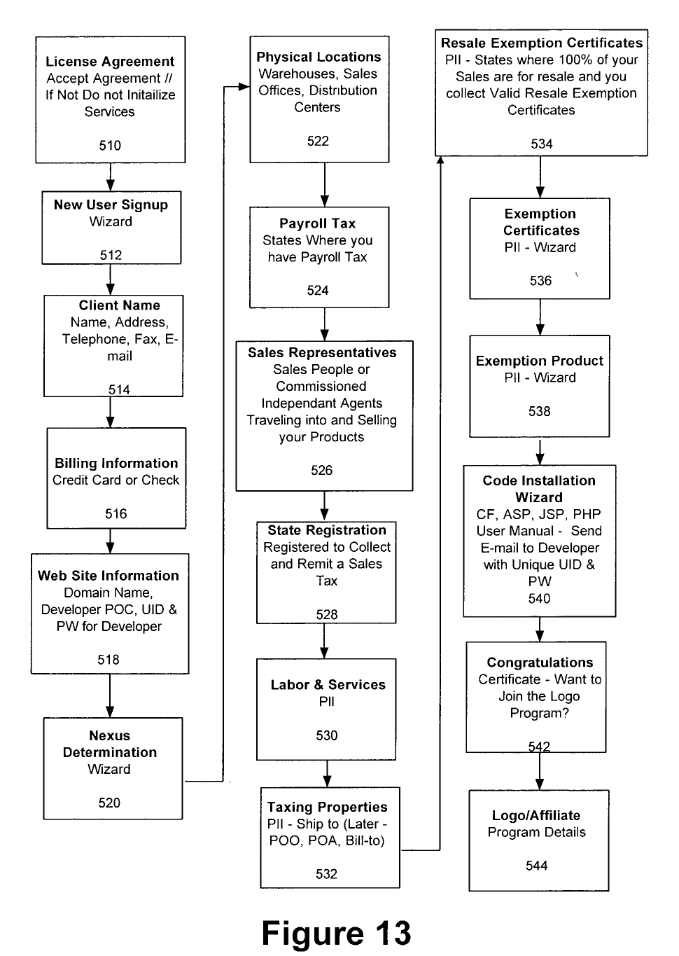

FIG. 13 is a flowchart illustrating an example of a process in an ASP embodiment of the system 20 beginning with the review of a license agreement at 510 through the installation process at 540 through joining a logo/affiliate program at 544.

At 510, the potential subscriber reviews the license agreement. If the agreement is not accepted by the merchant 26 or subscriber, then no tax calculation services should be provided by the system 20.

At 512, the new user signup wizard is invoked to walk new subscriber through the sign-up process. Merchant data 30 is entered at 514. Billing information such as credit card or check data and other subscription data 34 can be entered at 516.

Web site information such as domain name and developer information can be provided at 518. This information allows online carts on the merchant page 200 to communicate in a transparent manner with the system 20.

A nexus determination wizard can be invoked at 520. In many embodiments, the actual determination is left to the legal judgment of the subscriber. In other embodiments, the system 20 supplies the legal judgment to facts made known to the system 20.

Information relating to the location and functions of physical locations can be entered at 522. Physical locations can include warehouses, sales offices, distribution centers, and other location types.

Payroll tax information can be supplied at 524. In a preferred embodiment, the merchant 26 identifies the jurisdictions in which payroll tax is paid by the merchant 26.

Sales representative information can be entered at 526. Employees as well as commissioned and independent agents can be inputted into the system 20. Traveling profiles and location information can also be included.

State registration information can be received by the system 20 at 528. The merchant 26 can identify states in which sales taxes are collected and remitted.

A labor and services determination at 530 can allow the merchant 26 to collect exemption certificates based on the labor and/or services provided by the merchant 26.

Taxing properties at 532 relating to characteristics such as ship to, ship from, POO, POA, and Bill-to, can be entered into the system 20 by the merchant 26.

At 534, the system 20 can determine whether resale exemption certificates should be issued because 100% of the sales activities in a particular state or other jurisdiction, are solely for resale. Those certificates can be issued at 536. Product-based exemptions based on product classifications can be identified by the system 20 at 538.

In some embodiments, code and data are stored on the access device 28 of the merchant 26 used by the merchant 26 to access the system 20. In some embodiments, code and data used to integrate merchant 26 online carts with the system 20 may require additional code components. Regardless of the purpose of the code and data components, they can be installed through the use of an installation wizard at 540.

A congratulatory message can be sent at 542, along with an invitation to join the logo/affiliates program. Details of such additional programs can be provided at 544.

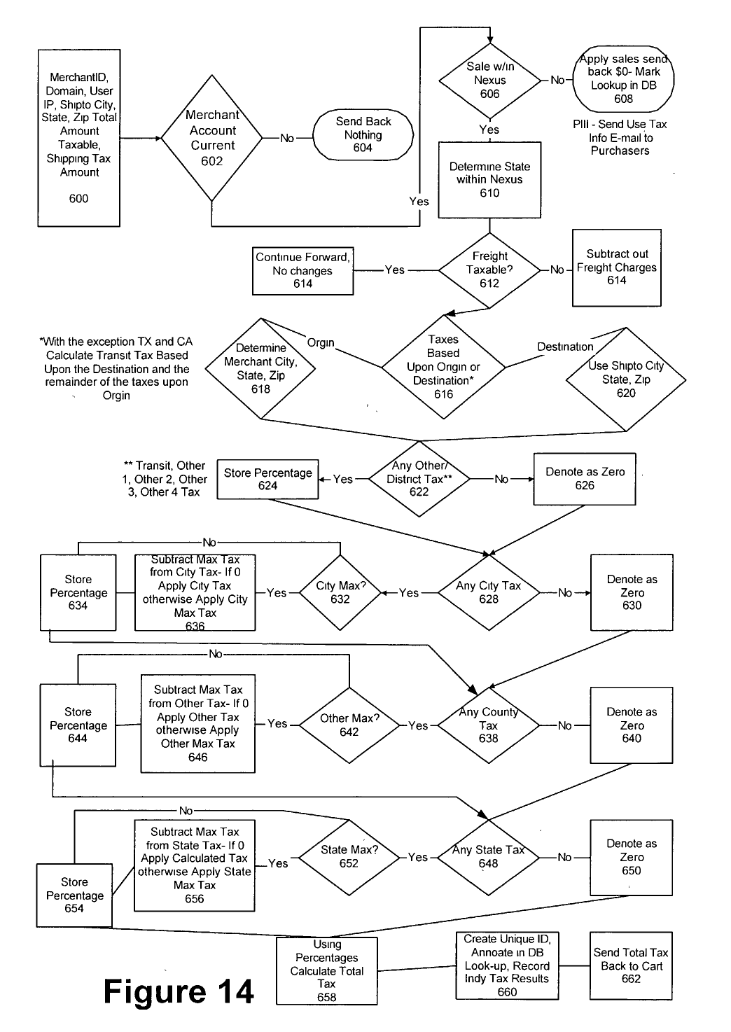

FIG. 14 is a flow chart illustrating one example of a tax calculation process. At 600, merchant data 30, subscription data 34, and transaction data 32 are accessed by the system 20. At 602, the system 20 determines whether or not the merchant 26 has a current account with the ASP. If the merchant 26 does not have a current account, no information is sent back the merchant 26 at 604.

If the merchant 26 has a current account, the system 20 determines at 606 whether or not the transaction is occurring within jurisdiction in which the merchant 26 has a nexus. If no nexus exists at 608, then no sales tax is due, and sales tax that was applied should be sent back, and the lookup can be recorded on the tax database 40.

If a nexus does exist, the state relating to the nexus is identified at 610. At 612, a freight taxable table is viewed by the system 20. If not, no charges are added at 614. If freight is taxable at 614, the freight charges can be subtracted out.

At 616, the system 20 determines whether or not the jurisdiction is an origin jurisdiction at 618 or a destination jurisdiction 620. The transaction location and address information is controlled by the determination at 616.

At 622, the system 20 determines whether or not any other taxes such as storage taxes may be due. If such taxes are due, the percentages can be stored at 618. Otherwise, the percentage of such taxes can be designated as zero at 626.

At 628, the system 20 determines whether or not any city taxes are due. If none are due at 630, the system 20 denotes the city tax value as zero. If city taxes are due, the system determines at 632 whether a maximum tax exists. If no maximum tax exists, the tax percentage is stored at 634. It a maximum tax exists at 632, the applicable tax percentage is calculated at 636 by comparing the maximum tax to the city tax.

At 638, the system 20 determines whether or not any county taxes are due. If none are due at 640, the system 20 denotes the county tax value as zero. If county taxes are due, the system determines at 642 whether a maximum tax exists. If no maximum tax exists, the tax percentage is stored at 644. It a maximum tax exists at 642, the applicable tax percentage is calculated at 646 by comparing the maximum tax to the county tax.

At 658, the system 20 determines whether or not any state taxes are due. If none are due at 650, the system 20 denotes the state tax value as zero. If state taxes are due, the system determines at 652 whether a maximum tax exists. If no maximum tax exists, the tax percentage is stored at 654. It a maximum tax exists at 652, the applicable tax percentage is calculated at 656 by comparing the maximum tax to the state tax.

At 658, the total transaction percentage is calculated by the system 20. At 660, unique IDs are created in the database, with all results being stored in the system 20. At 662, the total transaction tax 48 is sent back to the merchant's 26 online cart.

In the claims:

1. A system for calculating transaction-based taxes, comprising:
a transaction subsystem, including a transaction characteristic and an online shopping cart, wherein said transaction subsystem is configured to receive said transaction characteristic from said online shopping chart;
a subscription subsystem, including a nexus characteristic and a signup interface, wherein said nexus characteristic is selected through said signup interface; and
a tax calculator, including a tax calculation, wherein said tax calculator generates said tax calculation from said transaction characteristic and said nexus characteristic.

2. The system of claim 1, further including a plurality of transaction characteristics comprising a cost, a location, and a classification.

3. The system of claim 2, wherein said cost includes a shipping cost.

4. The system of claim 2, further comprising a nine-digit zip code, wherein said system generates said nine-digit zip code from said location.

5. The system of claim 1, further including a plurality of subscription characteristics, comprising a click license.

6. The system of claim 5, wherein said click license provides for a per transaction charge.

7. The system of claim 5, wherein said click license provides for a flat fee charge.

8. The system of claim 1, further comprising a merchant subsystem, wherein said merchant subsystem provides for modifying said nexus characteristic.

9. The system of claim 8, wherein said merchant subsystem includes an exemption module and an exemption characteristic, wherein said exemption module provides for receiving said exemption characteristic, and wherein said tax calculation is generated with said exemption characteristic.

10. The system of claim 9, further including a plurality of exemption characteristics, including a list of exempt customers and a list of exemptions.

11. The system of claim 10, wherein said exemption module is configured to modify said list of exempt customers and said list of exemptions.

12. The system of claim 1, further comprising a collection subsystem and a tax authority interface, wherein said tax calculation is reported to said tax authority interface without human intervention by said collection subsystem.

13. The system of claim 12, further comprising a transaction tax and an electronic payment, wherein said transaction tax is collected without human intervention by said collection subsystem in the form of said electronic payment when said transaction tax is incurred.

14. The system of claim 13, wherein said electronic payment is forwarded to said tax authority interface without human intervention.

15. The system of claim 1, further comprising a database, wherein said nexus characteristic is stored on said database and wherein said nexus characteristic is configured for repeated use.

16. The system of claim 1, further comprising an administrative subsystem, an updated click license and an updated merchant characteristic, wherein said system is configured to receive said updated click license and said updated merchant characteristic through said administrative subsystem.

17. The system of claim 1, further comprising a network and a network access device, wherein said network includes a server side and a client side, wherein said network access device is located on said client side and wherein said transaction subsystem and said subscription subsystem are located on said server side.

18. The system of claim 17, further comprising a plurality of client sides, wherein said server side is a third party administrator server connected to said plurality of client sides.

19. The system of claim 17, further comprising a database to store said transaction characteristic and said subscription characteristic wherein said database is located on said server side of said network.

20. The system of claim 17, further comprising a merchant website, wherein said online cart is located in said merchant website, and wherein said merchant website is said network access device.

21. The system of claim 1, wherein said transaction characteristic is a location, wherein said location is not a mailing address.

22. A system for calculating transaction-based taxes, comprising:
an interface subsystem, including:
a transaction interface and a plurality of transaction characteristics, wherein said plurality of transaction characteristics comprise a cost, a location, and a classification, wherein said transaction interface is configured to receive said plurality of transaction characteristics; and
a merchant interface and a plurality of merchant characteristics, wherein said plurality of merchant characteristics comprise an exemption characteristic and a nexus characteristic, wherein said merchant interface is configured to receive and store said plurality of merchant characteristics for repeated access;
a database, comprising a plurality of extended zip codes, wherein said plurality of extended zip codes includes a particular extended zip code, wherein said system identifies one said particular extended zip code from said plurality of extended zip codes with said location from said transaction interface; and
a tax calculator, including a tax calculation, wherein said tax calculator provides for generating said tax calculation from said plurality of transaction characteristics, said plurality of merchant characteristics, and said particular extended zip code.

23. The system of claim 22, further comprising a subscription module and a subscription characteristic, wherein at least one said merchant characteristic is said subscription characteristic.

24. The system of claim 23, wherein said subscription characteristic is a nexus characteristic.

25. The system of claim 24, wherein said nexus characteristic is a user-selected nexus characteristic.

26. The system of claim 22, wherein said transaction interface is configured to receive said plurality of transaction characteristics from an online shopping chart.

27. A method of providing subscribers with transaction-related sites on the Web with a tax calculation for a particular transaction process, comprising:
receiving a plurality of subscriber characteristics during a setup process of a subscriber;
configuring an interface system to capture a plurality of transaction characteristics relating to a particular transaction process, wherein said plurality of transaction characteristics relate to a transaction in which the subscriber is a party; and
generating a tax calculation for the particular transaction process from said plurality of subscriber characteristics and said plurality of transaction characteristics.

28. The method of claim 27, further comprising:
sending said tax calculation to an online cart on a subscriber website.

29. The method of claim 28, wherein said sending of said tax calculation is transparent to a user of the subscriber website.

30. The method of claim 27, further comprising displaying a click license configured for execution.

31. The method of claim 30, further comprising setting a ASP fee in said click license.

32. The method of claim 27, further comprising modifying said plurality of subscriber characteristics after the setup process is completed.

33. The method of claim 27, further comprising collecting the tax indicated by the tax calculation.

34. The method of claim 33, further comprising forwarding the collected tax to a tax authority.
